(19) United States
(12) Patent Application Publication
(10) Pub. No.: US 2007/0035655 A1
(43) Pub. Date: Feb. 15, 2007

(54) Multi-functional scanning camera

(76) Inventors: Chang-Fu Chen, Taipei Hsien (TW); Chih-Ming Huang, Taipei (TW); Yi-Cheng Su, Taipei Hsien (TW); Chien-Cheng Chen, Taipei Hsien (TW); Chih-Hao Chen, Taipei Hsien (TW); Tomas-Gavin Melia, Taipei Hsien (TW)

Correspondence Address: Chang-Fu Chen, 235 Chung-Ho, Box 8-24, Taipei, TW

(21) Appl. No.: 11/200,089

(22) Filed: Aug. 10, 2005

(51) Int. Cl. H04N 5/225

(52) U.S. Cl. 348/373

(57) ABSTRACT

A multi-functional scanning camera comprises a rear cover; a front cover combined to the rear cover; a main back casing; a left telescopic rod; a right telescopic rod; a left fixing unit and a right fixing unit locked to two sides of the back casing; a main front casing assembled to a main back casing; and a lower side of a rear end of the main back casing being installed with a left rotary retaining seat and a right rotary retaining seat. The scanning operation will not affect the operation of network operation. The scanner is extendable and foldable. The plurality of light emitting diodes serves to illuminate the documents located below and the adjusting button serves to adjust the illumination so that the words on the document are shown clearly.

### FIELD OF THE INVENTION

The present invention relates to scanner, and in particular to a multi-functional scanning camera, wherein the scanning operation will not affect the operation of network operations. The present invention is extendable and foldable. A plurality of light emitting diodes serve to illuminate the documents located below and adjusting button serves to adjust the illumination so that the words on the document are shown clearly. 10 Moreover, the present invention can be carried out conveniently.

### BACKGROUND OF THE INVENTION

In the prior art scanner, the documents to be scanned are placed upon a transparent glass of a scanner. A motor serves to drive a lens to move through the documents. The scanner is operated through a plane and the resolution is low. The operation cannot be performed with other functions, such as video talk or photo capture, etc. Furthermore, the scanner has a large size so it is not suitable to be used in offices. Furthermore, conventionally, the scanner needs much time in operations so that the efficiency is low. Furthermore, the large size makes it difficult to be stored.

### SUMMARY OF THE INVENTION

Accordingly, the primary object of the present invention is to provide a multi-functional scanning camera, wherein the scanning operation will not affect the operation of network operation. The present invention is extendable and foldable. A plurality of light emitting diodes serve to illuminate the documents located below and the adjusting button serves to adjust the illumination so that the words on the document be shown clearly. Moreover, the present invention can be carried out conveniently.

To achieve above objects, the present invention provides a multi-functional scanning camera. The multi-functional scanning camera comprises a rear cover; a front cover being combined to the rear cover; a main back casing; a left telescopic; a right telescopic rod; a left fixing unit and a right fixing unit being locked to inner two sides of the back casing; a main front casing being assembled to the main back casing; a lower side of a rear end of the main back casing being installed with a left rotary retaining seat and a right rotary retaining seat; an interior thereof being installed with ribs and for connecting ribs of the rear rotary fixing seat. The scanning operation will not affect the operation of network operation. The scanner is extendable and foldable. The plurality of light emitting diodes serve to illuminate the documents located below and the adjusting button serves to adjust the illumination so that the words on the document be shown clearly.

The various objects and advantages of the present invention will be more readily understood from the following detailed description when read in conjunction with the appended drawing.

### BRIEF DESCRIPTION OF THE DRAWINGS

FIG. 1 is an exploded perspective view of a multi-functional scanning camera of the present invention.

FIG. 2 is a first partial assembly view of supporting frame of the multi-functional scanning camera of the present invention.

FIG. 3 is a second partial assembly view of the multi-functional scanning camera of the present invention.

FIG. 4 is a third partial assembly view of the multi-functional scanning camera of the present invention.

FIG. 5 is a fourth partial assembly view of the multi-functional scanning camera of the present invention.

FIG. 6 is an expanded view of the multi-functional scanning camera of the present invention.

FIG. 7 shows the first shortening operation of the multi-functional scanning camera of the present invention.

FIG. 8 shows the second shortening operation of a multi-functional scanning camera of the present invention.

FIG. 9 shows the folding operation of a multi-functional scanning camera of the lens of the present invention.

FIG. 10 shows the folding operation of a multi-functional scanning camera of the present invention.

FIG. 11 is an assembled view of a multi-functional scanning camera of the present invention.

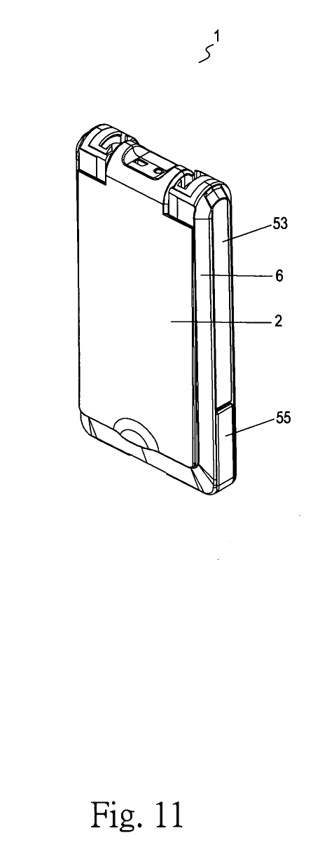

FIG. 12 shows one embodiment of the multi-functional scanning camera of the present invention.

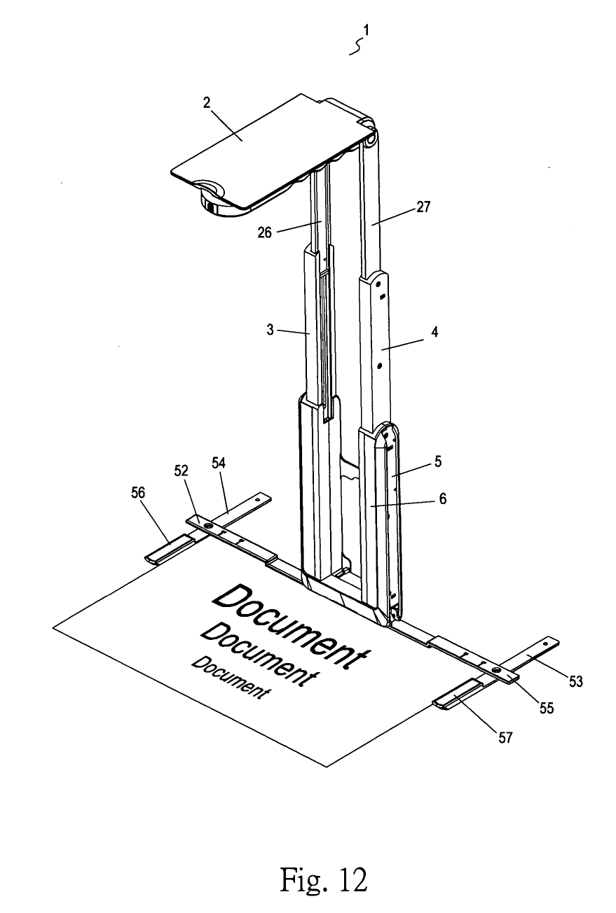

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

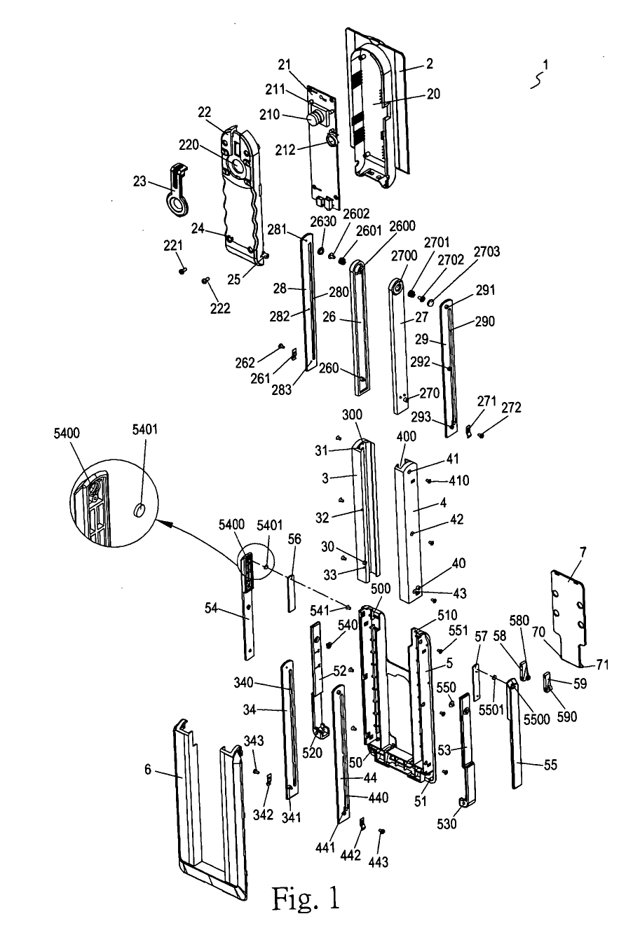

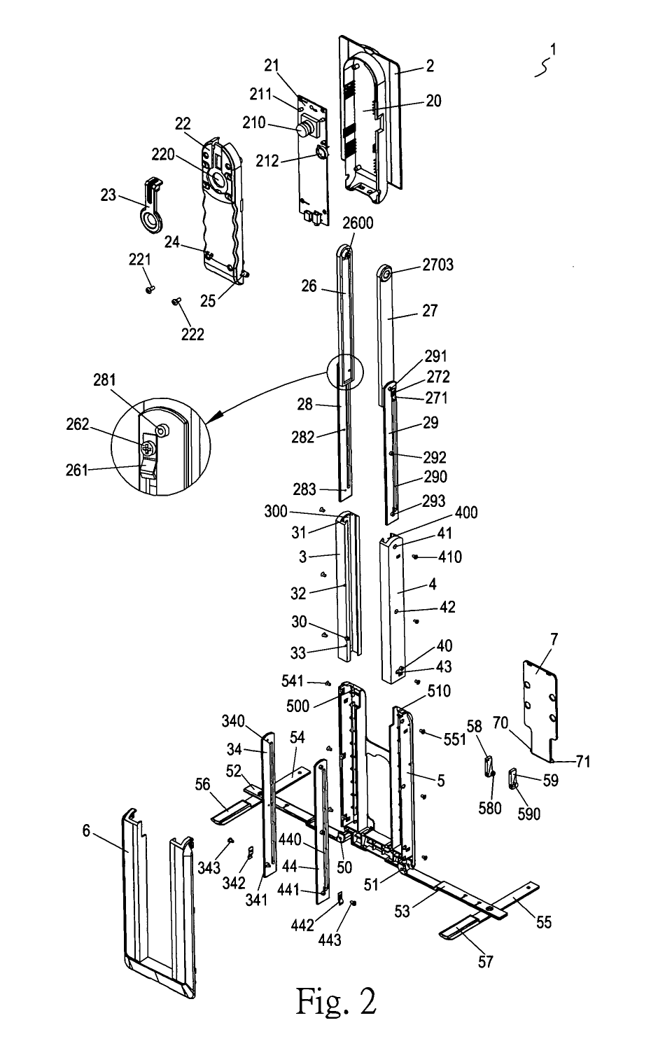

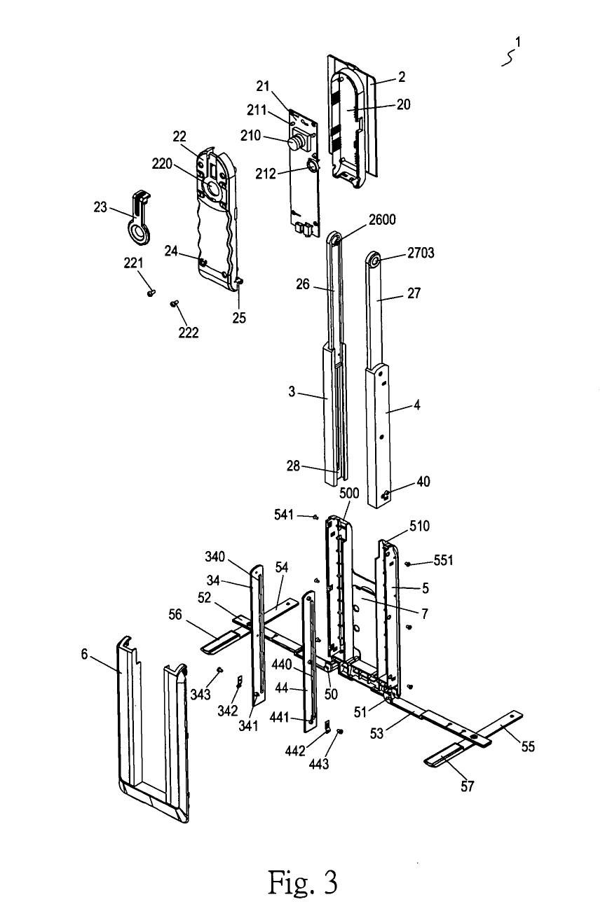

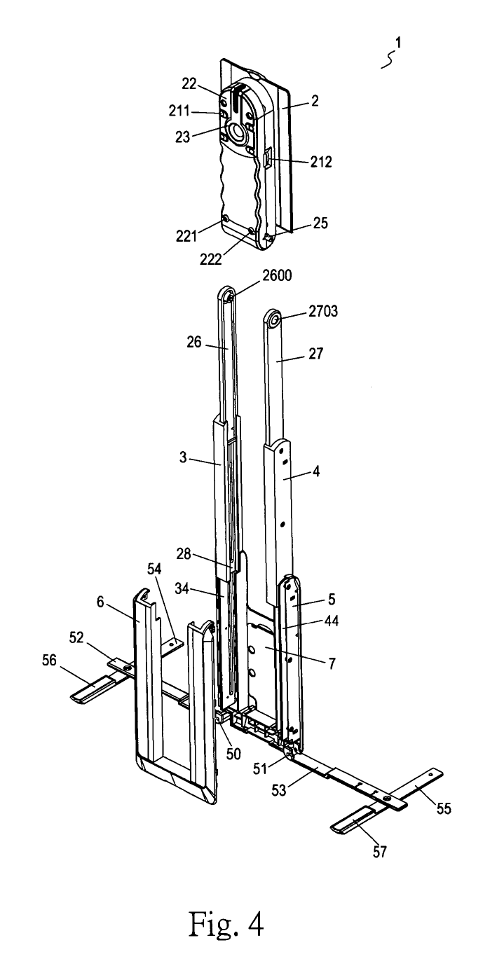

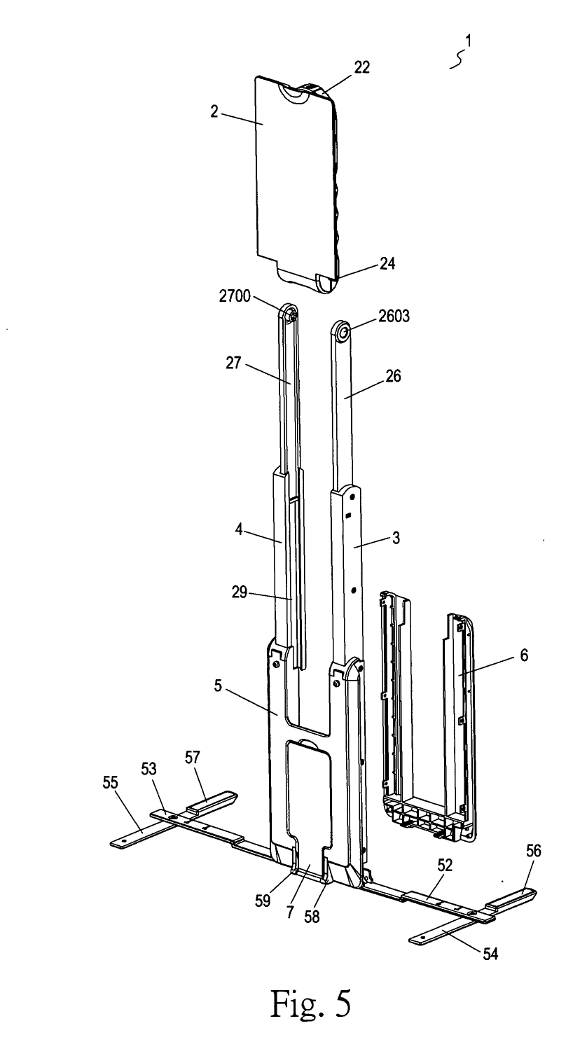

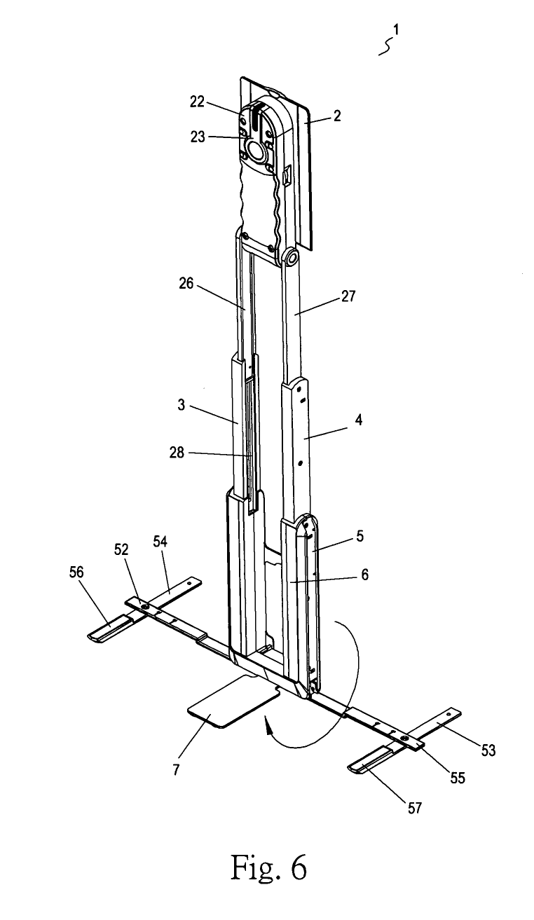

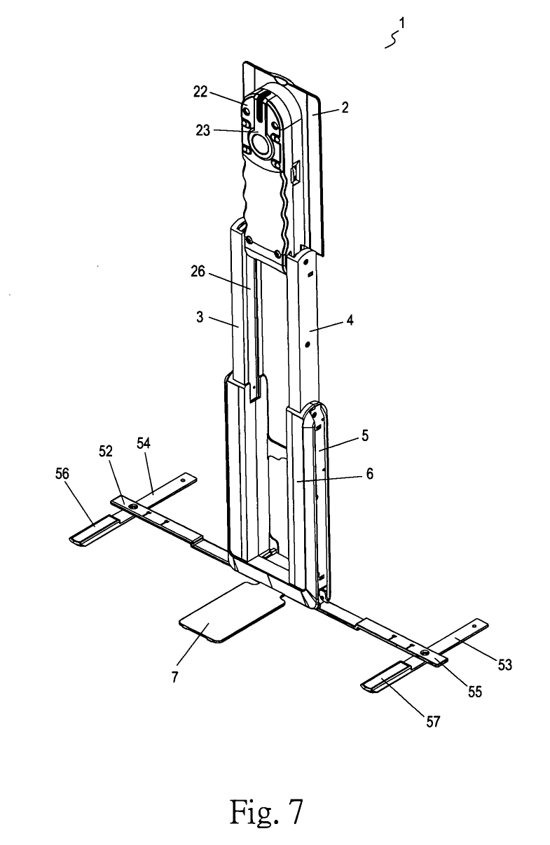

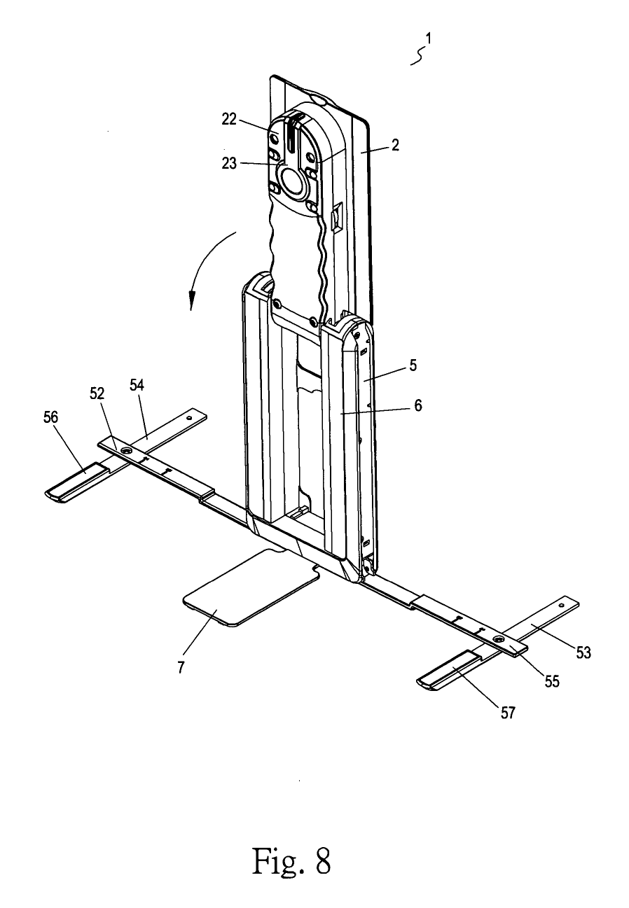

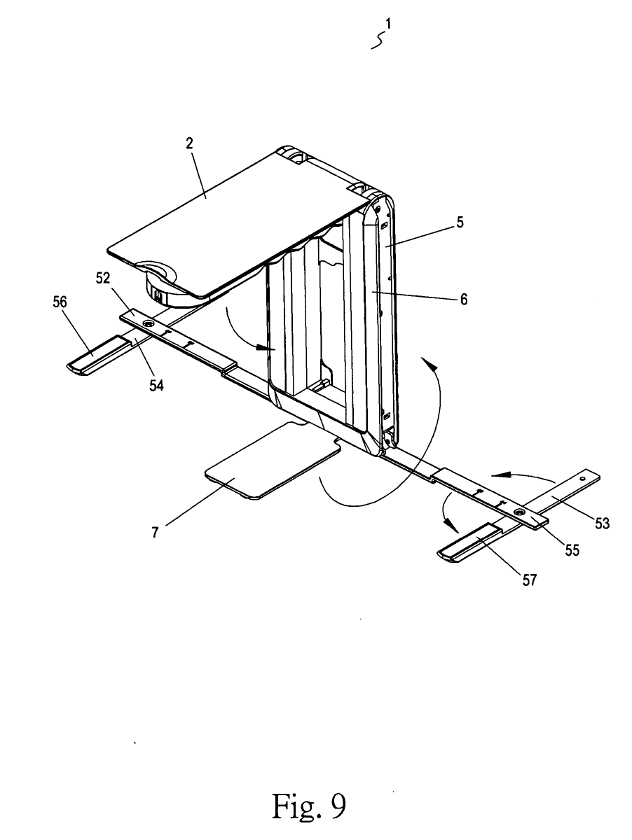

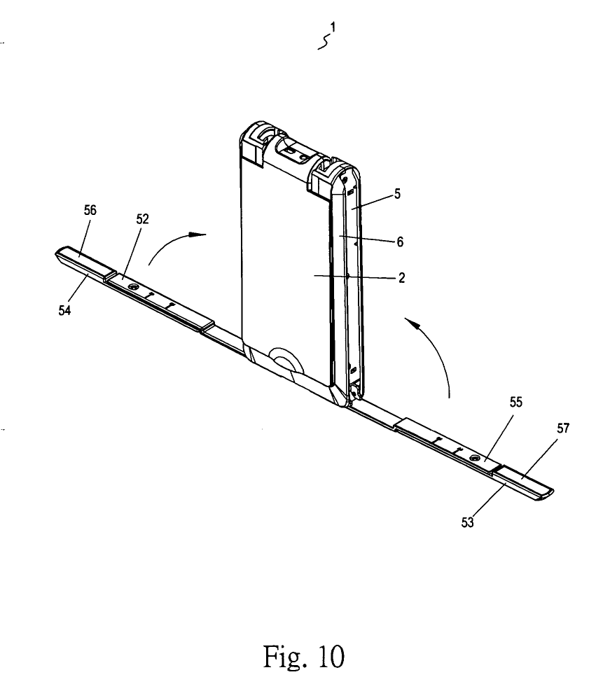

Referring to FIGS. 1 to 10, the scanning camera 1 of the present invention has the following elements.

A rear cover 2 has a chamber 20 at a front end thereof. A base plate 21 is installed in the chamber 20. A front end of the base plate 21 is installed with a lens 210. A lower side of the lens 210 is installed with a plurality of light emitting diodes 211. A lateral side of the base plate 21 is firmly secured with an adjusting button 212 for adjusting the illumination of the light emitting diodes 211.

A front cover 22 is combined to the rear cover 2 by screws 221, 222. The lens 210 passes through a via hole 220 of the front cover 22. An upper side of the front cover 22 has a decorating cover 23. Two sides of a lower end of the front cover 22 extends with two posts 24, 25 which are embedded into the through holes 2600, 2700 of a left rotary rod 26 and a right rotary rod 27, respectively. The left rotary rod 26 and right rotary rod are locked by springs 2601, and 2701 and screws 2602 and 2702, respectively. Each of the screw is sealed by rubber pads 2603 and 2703.

A distal end of the left rotary rod 26 is installed with a left nose 260 and a left retainer 28. An outer side of the left retainer 28 is installed with a left limiter 261. A screw 262 passes through a left recess 280 of the left retainer 28 to be screwed to the left nose 260 of the left rotary rod 26 so that the left limiter 261 has a function of stability so as to prevent the left rotary rod 26 from falling out due to being over-extension upwards.

A distal end of the right rotary rod 27 is installed with a right nose 270 and a right retainer 29. An outer side of the right retainer 29 is installed with a right limiter 271. A screw 272 passes through a right recess 290 of the right retainer 29 to be screwed to the right nose 270 of the right rotary rod 27 so that the right limiter 271 has a function of stability to prevent the right rotary rod 27 from falling out due to being over-extension upwards.

A main back casing 5 is included.

A left telescopic rod 3 is formed with a left trench 300. A lateral side of the left trench 300 is formed with a plurality of through holes 31, 32, and 33. A plurality of screws 410 passes through the through holes 31, 32, 33 of the left telescopic rod 3 and the screw holes 281, 282 and 283 of the left retainer 28 to motionlessly fix the left retainer 28 to the left telescopic rod 3. The left telescopic rod 3 is slidable in the left recess 280 by the left limiter 261. A distal end of the left telescopic rod 3 is installed with a left nose 30 which is connected to a left fixing unit 34. A distal end of the left fixing unit 34 has a screw hole 341. Thereby the left fixing unit is fixed to a left side of the main back casing 5. An outer side of the left fixing unit 34 is installed with a left limiting sheet 342. A screw 343 passes through a slot. 340 of the left fixing unit 34 to be screwed into the left nose 30 of the left telescopic rod 3 so that the left limiting sheet 342 is retained in the slot 340 to guide and stabilize the left limiting sheet 342 in the slot 340 so that the left telescopic rod 3 will not fall out due to being over-pull upwards.

A right telescopic rod 4 is formed with a right trench 400. A lateral side of the right trench 400 is formed with a plurality of through holes 41, 42, and 43. A plurality of screws 410 passes through the through holes 41, 42, 43 of the right telescopic rod 4 and the screw holes 291, 292 and 293 of the right retainer 29 so as to motionlessly fix the right retainer 29 to the right telescopic rod 4. The right telescopic rod 4 is slidable in the right recess 290 by the right limiter 271. A distal end of the right telescopic rod 4 is installed with a right nose 40 which is connected to a right fixing unit 44. A distal end of the right fixing unit 44 has a screw hole 441. Thereby the right fixing unit is fixed to a right side of the main back casing 5. An outer side of the right fixing unit 44 is installed with a right limiting sheet 442. A screw 443 passes through a slot 440 of the right fixing unit 44 to be screwed into the right nose 40 of the right telescopic rod 4 so that the right limiting sheet 442 is retained in the slot 440 to guide and stabilize the right limiting sheet 442 in the slot 440 so that the right telescopic rod 4 will not fall out due to being over-pull upwards.

The left fixing unit 34 and the right fixing unit 44 are locked to the inner two sides of the back casing 5.

A main front casing 6 is assembled to the main back casing 5 so as to form a left groove 500 and a right chamber 510 for receiving the left telescopic rod 3 and right telescopic rod 4. A bottom of the main back casing 5 are extended with the noses 50 and 51 for embedding into the holes 520, 530 of a left supporter 52 and a right support 53. The left supporter 52 and the right supporter 53 can expand and rotate through 90 degrees.

A distal end of the left supporter 52 is installed with a left rotary frame 54 which are locked by a screw 540 to be rotatable through 90 degrees so that the left supporter 52 and the left rotary frame 54 are formed as a cruciform. One end of the left rotary frame 54 is formed with a left receiving groove 5400. A magnet is received in the receiving groove 5401. A left covering sheet 56 covers upon the left receiving groove 5400. The magnet 5401 serves to attract a screw 540 to prevent the screw 541 from falling out. When the left support 52 is not used, the left rotary frame 54 is rotated to be aligned with the left supporter 52.

A distal end of the right supporter 53 is installed with a right rotary frame 55 which is locked by a screw 550 so as to be rotated through 90 degrees so that the right supporter 53 and the right rotary frame 55 are formed as a cruciform. One end of the right rotary frame 55 is formed with a right receiving groove 5500. A magnet is received in the receiving groove 5501. A right covering sheet 57 covers upon the right receiving groove 5500. The magnet 5501 serves to attract a screw 550 so as to prevent the screw 551 from falling out. When the right support 53 is not used, the right rotary frame 55 is rotatable so as to be aligned with the right supporter 53.

A lower side of the rear end of the main back casing 5 is installed with a left rotary retaining seat 58 and a right rotary retaining seat 59. An interior thereof is installed with ribs 580 and 590 for connecting the ribs 70, 71 of the rear rotary fixing seat 7. The rear rotary fixing seat 7 can rotate through 270 degrees from a rear end to a front end so as to form a three supporting legs with the left supporting frame 52 and the right supporting frame 53. Thereby a scanning document can be placed between the left rotary frame 54 and the right rotary frame 55.

Advantages of the present invention are that the scanning operation will not affect the operation of network operation. The present invention is extendable and foldable. The plurality of light emitting diodes serves to illuminate the documents located below and the adjusting button serves to adjust the illumination so that the words on the document are shown clearly. Thereby the present invention can be carried out conveniently.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multi-functional scanning camera comprising:
a rear cover having a chamber at a front end thereof; a base plate being installed in the chamber; a front end of the base plate being installed with a lens; a lower side of the lens being installed with a plurality of light emitting diodes; a lateral side of the base plate being firmly secured with an adjusting button for adjusting the illumination of the light emitting diodes;
a front cover being combined to the rear cover by first screws; the lens passing through a via hole of the front cover; an upper side of the front cover having a decorating cover; two sides of a lower end of the front cover extending with two posts, which being embedded into the through holes of a left rotary rod and a right rotary rod, respectively; the left and right rotary rods being locked by springs and second screws respectively; each of the second screw being sealed by rubber pads and;
a distal end of the left rotary rod being installed with a left nose and a left retainer; an outer side of the left retainer being installed with a left limiter; a third screw passing through a left recess of the left retainer to be screwed to the left nose of the left rotary rod so that the left limiter having a function of stability to prevent the left rotary rod from falling out due to being over-extension upwards;
a distal end of the right rotary rod being installed with a right nose and a right retainer; an outer side of the right retainer being installed with a right limiter; a fourth screw passing through a right recess of the right retainer to be screwed to the right nose of the right rotary rod so that the right limiter has a function of stability to prevent the right rotary rod from falling out due to being over-extension upwards;
a main back casing;
a left telescopic rod being formed with a left trench; a lateral side of the left trench being formed with a plurality of through holes; a plurality of fifth screws passing through the through holes of the left telescopic rod and the screw holes of the left retainer so as to motionlessly fix the left retainer to the left telescopic rod; the left telescopic rod being slidable in the left recess by the left limiter; a distal end of the left telescopic rod being installed with a left nose which being connected to a left fixing unit; a distal end of the left fixing unit having a screw hole; thereby the left fixing unit being fixed to a left side of the main back casing; an outer side of the left fixing unit being installed with a left limiting sheet; a sixth screw passes through a slot of the left fixing unit to be screwed into the left nose of the left telescopic rod so that the left limiting sheet is retained in the slot to guide and stabilize the left limiting sheet in the slot so that the left telescopic rod will not fall out due to being over-pull upwards;
a right telescopic rod being formed with a right trench; a lateral side of the right trench being formed with a plurality of through holes; a plurality of seventh screws passing through the through holes of the right telescopic rod and the screw holes of the right retainer so as to motionlessly fix the right retainer to the right telescopic rod; the right telescopic rod being slidable in the right recess by the right limiter; a distal end of the right telescopic rod being installed with a right nose which is connected to a right fixing unit; a distal end of the right fixing unit having a screw hole; thereby the right fixing unit being fixed to a right side of the main back casing; an outer side of the right fixing unit being installed with a right limiting sheet; an eighth screw passing through a slot of the right fixing unit to be screwed into the right nose of the right telescopic rod so that the right limiting sheet being retained in the slot so as to guide and stabilize the right limiting sheet in the slot so that the right telescopic rod will not fall out due to being over-pull upwards;
the left fixing unit and the right fixing unit being locked to two sides of an interior of the back casing;
a main front casing being assembled to the main back casing so as to form a left groove and a right chamber for receiving the left telescopic rod and right telescopic rod; a bottom of the main back casing being extended with the noses and for embedding into the holes of a left supporter and a right support; the left supporter and the right supporter can expand and rotate through 90 degrees;
a distal end of the left supporter being installed with a left rotary frame which being locked by a ninth screw; one end of the left rotary frame being formed with a left receiving groove; a magnet being received in the receiving groove for attracting the tenth screw so as to prevent the tenth screw from falling out; when the left support is not used, the left rotary frame is rotatable so as to be aligned with the left supporter;
a distal end of the right supporter being installed with a right rotary frame; one end of the right rotary frame being formed with a right receiving groove; a magnet being received in the receiving groove; the magnet serving to attract the eleventh screw to prevent the eleventh screw from falling out; when the right support is not used, the right rotary frame is rotatable to be aligned with the right supporter; and
a lower side of a rear end of the main back casing being installed with a left rotary retaining seat and a right rotary retaining seat; an interior thereof being installed with ribs and for connecting ribs of the rear rotary fixing seat.

2. The multi-functional scanning camera as claimed in claim 1, wherein as the left rotary frame is rotated through 90 degrees, the left supporter and the left rotary frame are formed as a cruciform; and as the right rotary frame is rotated through 90 degrees, the right supporter and the right rotary frame are formed as a cruciform.

3. The multi-functional scanning camera as claimed in claim 1, wherein the rear rotary fixing seat is rotatable through 270 degrees from a rear end to a front end so as to form a three supporting legs with the left supporting frame and the right supporting frame; thereby a scanning document can be placed between the left rotary frame and the right rotary frame.

4. The multi-functional scanning camera as claimed in claim 1, wherein a left covering sheet covers upon the left receiving groove and a right covering sheet covers upon the right receiving groove.
